(19) United States
(12) Patent Application Publication
(10) Pub. No.: US 2016/0236192 A1
(43) Pub. Date: Aug. 18, 2016

(54) RAMAN SAMPLE CELL

(71) Applicant: Thermo Electron Scientific Instruments LLC, Madison, WI (US)

(72) Inventors: Min YAN, Verona, WI (US); Joseph A. CLEARY, Blanchardville, WI (US); Richard C. WIEBOLDT, Verona, WI (US); Paul S. ZDINAK, Belleville, WI (US)

(21) Appl. No.: 15/042,544

(22) Filed: Feb. 12, 2016

Related U.S. Application Data
(60) Provisional application No. 62/116,689, filed on Feb. 16, 2015.

(51) Int. Cl. B01L 3/00; G01N 21/65

(52) U.S. Cl. CPC B01L 3/508; G01N 21/65; B01L 2300/0832; B01L 2300/042; B01L 2200/141; B01L 2300/06

(57) ABSTRACT

A sample cell includes a cell body having a proximal end, a distal end, a circumference, and a sample holding surface on the proximal end, an o-ring around the circumference, a cap disposed over the proximal end of the cell body, the cap forming a seal with the o-ring, and a window in the cap located at an adjustable distance from the sample holding surface.

### CROSS-REFERENCE TO RELATED APPLICATIONS

This application claims priority to U.S. provisional patent application Ser. No. 62/116,689, filed Feb. 16, 2015 entitled “Raman Sample Cell,” which is incorporated herein by reference in its entirety.

### FIELD OF THE INVENTION

The present invention is generally directed to a sample cell.

### BACKGROUND

Spectrographs (sometimes referred to as spectrometers) are common instruments used to measure the properties of input light across the component wavelengths of the input light, e.g., the intensity of the light at some or all of the component wavelengths of the input light. They are particularly useful in the fields of material and chemical analysis, where light of different types (infrared, visible, and/or ultraviolet) may be directed onto a sample, and the resulting light reflected by, emitted by, and/or transmitted through the sample can then be supplied to and analyzed by the spectrograph. The resulting readings can provide information about the properties of the sample.

When illuminating light, such as a laser beam, is incident upon a sample material, molecular bonds in the material can be excited by the incident light and can emit radiation which can be detected as scattered light. The Rayleigh component of the scattered light corresponds to the light emitted when the molecule relaxes from the excited state to the ground state. Infrequently, the molecule relaxes to a different vibrational or rotational level in the ground state. This produces Raman scattering components at Stokes and anti-Stokes frequencies. A sample composed of multiple molecular species will produce a spectrum of such Raman scattering. The Raman scattering components can be detected and analyzed to help determine the composition of the sample.

Various instruments have been developed for analyzing Raman spectra including Raman microscopes in which a very small area on a sample can be analyzed to determine characteristics of the composition of the sample at that area. In a typical Raman microscope, narrow band or monochromatic illuminating light, such as laser light, is passed along a beam path through the objective lens of the microscope where it is focused at a focal point on a sample. The Raman scattering from the sample collected by the microscope objective is passed back on a beam path to a spectrograph which typically separates the Raman scattering radiation by wavelength and detects it.

Some sample materials can deteriorate rapidly in air, and therefore require handling in an inert (e.g., argon or nitrogen) atmosphere in a controlled-atmosphere chamber (sometimes referred to as a glove box). Examples of such air-sensitive sample materials include lithium ion battery components, such as electrode and separator materials. It is also often useful to analyze the same sample by different techniques, such as scanning electron microscopy (SEM) and Raman microscopy, while maintaining the sample in the same controlled-atmosphere environment. SEM analysis typically employs a variety of sample holders of different shapes and sizes, depending on whether, for example, an edge or a flat surface of the sample is being analyzed.

Therefore, there is a need for a sample cell for air-sensitive sample materials mounted on a variety of sample holders.

### SUMMARY

In one embodiment, a sample cell includes a cell body having a proximal end, a distal end, a circumference, and a sample holding surface on the proximal end. The sample cell further includes an o-ring around the circumference, a cap disposed over the proximal end of the cell body, the cap forming a seal with the o-ring, and a window in the cap located at an adjustable distance from the sample holding surface. The sample holding surface can include a recess adapted for a sample holder, and, optionally, a locking pin that secures the sample holder in the recess. In some embodiments, the window can be one of a calcium fluoride, quartz, glass, or magnesium oxide window. The sample cell can include a cell mounting plate connected to the distal end of the cell body. In certain embodiments, the cell body and cap can include matching threads. The cap can have a diameter in a range of between 1.6 inches and 2.0 inches, such as 1.83 inches. The adjustable distance can be in a range of between 0.0 inches and 0.26 inches, such as 0.01 inches.

In another embodiment, a method of holding a sample includes mounting a sample holder on a sample holding surface located on a proximal end of a cell body having a circumference, and an o-ring around the circumference, disposing a cap over the proximal end of the cell body, forming a seal with the o-ring, the cap including a window, and adjusting the distance between the window and the sample holding surface. The method can further include securing the sample holder with a locking pin, which can be located in a recess in the cell body. In some embodiments, the method can further include mounting the cell onto a cell mounting plate. In certain embodiments, adjusting the distance between the window and the sample holding surface can include threading the cap over the proximal end of the cell body.

The invention has many advantages, including enabling analysis of air-sensitive sample materials mounted on a variety of sample holders.

### BRIEF DESCRIPTION OF THE DRAWINGS

FIG. 1 illustrates a cross-section of the sample cell.

FIG. 2A illustrates a perspective view of the sample cell.

FIG. 2B illustrates a perspective view of a cross-section of the sample cell.

FIG. 3 illustrates a cross-section of the sample cell including a sample holder.

FIG. 4 illustrates the sample cell on a sample stage of a Raman microscope.

FIG. 5 is a photograph of an embodiment of the sample cell on a sample stage of a Raman microscope.

FIG. 6 is a flow chart of an exemplary method of holding a sample.

Like reference numerals refer to corresponding parts throughout the several views of the drawings.

### DETAILED DESCRIPTION OF EMBODIMENTS

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

In some embodiments, the sample cell described herein can be used, for example, for ex-situ battery studies of materials that will be deteriorated rapidly in open air. The sealed cap design enables the use of the sample cell in inert gas conditions to transfer sample material in and out of the cell. The design accepts standard SEM pin mounts, which have a variety of sizes and shapes. A user is able to mount a sample flat, for surface study, or mount the sample with one side facing up for cross section study. The SEM pin mount will facilitate transfer of samples between a Raman microscope and an SEM. The adjustable cap design allows for focus adjustment for different types of samples and different working distances from objectives, while maintaining the seal during the adjustment, because the air-tight adjustable seal allows the window, which is sealed into the cap, to move up and down for focus and working distance adjustment while still maintaining the seal during the adjustment. The sample cell is designed to be used with a standard Raman microscope stage or any microscope stage which accepts one or more (e.g., two) standard slides, which are typically 3 inches (7.6 cm) long and 1 inch (2.54 cm) wide. The replaceable cap enables multiple window material options for the sealed window, such as quartz, CaF₂, MgO, glass, or sapphire, or any other window materials which provide a clean Raman background for different samples.

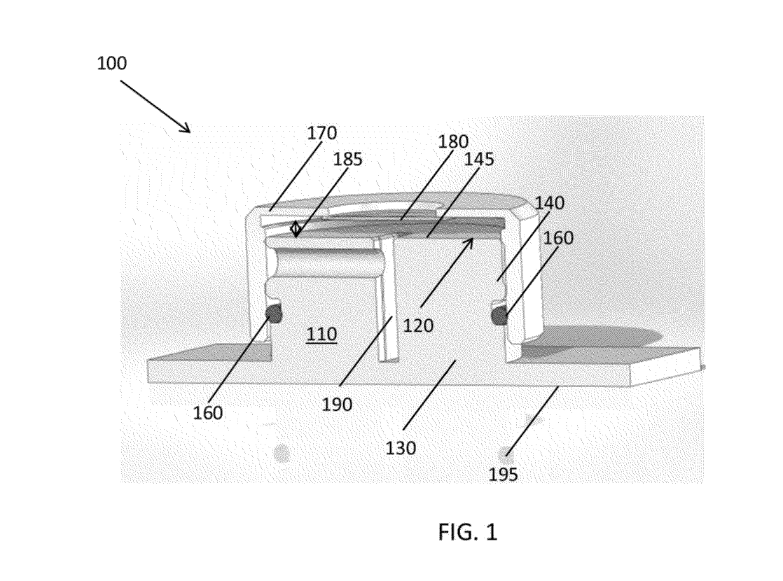

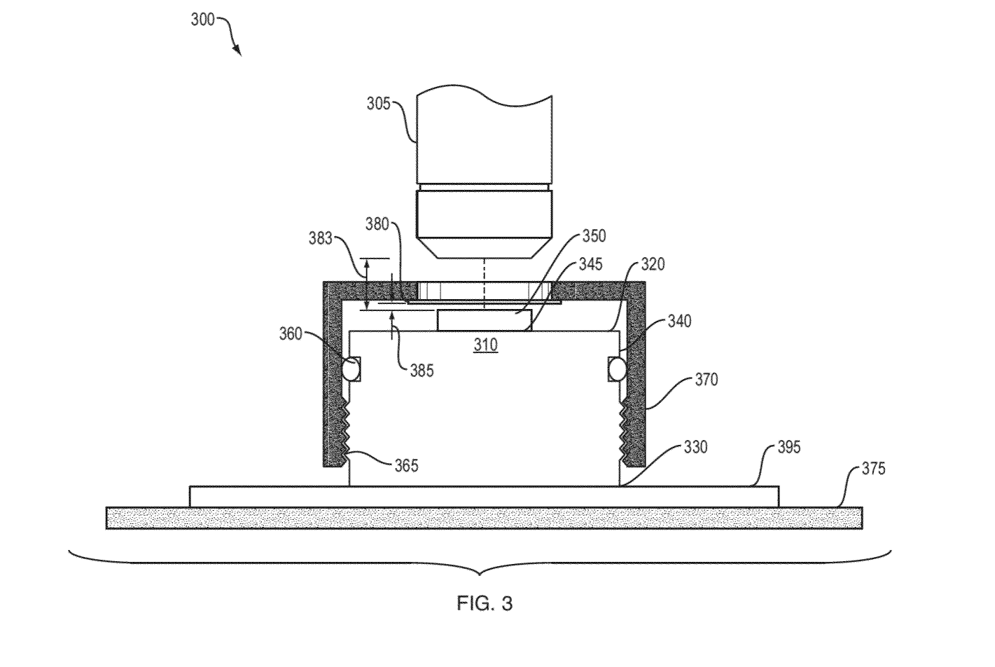

In one embodiment, as shown in FIG. 1, a sample cell 100 includes a cell body 110 having a proximal end 120, a distal end 130, a circumference 140, and a sample holding surface 145 on the proximal end 120, an o-ring 160 around the circumference 140, a cap 170 disposed over the proximal end 120 of the cell body 110, the cap 170 forming a seal with the o-ring 160, and therefore maintaining a controlled atmosphere around sample holding surface 145 such as an inert (e.g., argon or nitrogen) atmosphere established by assembling the cell in a glove box. The sample cell 100 also includes a window 180 that is sealed in the cap 170 and located at an adjustable distance 185 from the sample holding surface 145. In one aspect, the distance 185 is adjustable due to the cap 170 and cell body 110 being configured with threads (shown in FIG. 3), so that the cap 170 can be lowered onto the cell body 110 while maintaining the seal with the o-ring 160. The sample holding surface 145 can include a recess 190 adapted for a sample holder (shown in FIG. 3). In one exemplary embodiment, the diameter of the cap 170 is in a range of between 1.6 inches (4.1 cm) and 2.0 inches (5.1 cm), such as 1.8 inches (4.6 cm).

The sample cell 100 can be made of a variety of materials. The cell body 110, cap 170, and mounting plate 195 can be made of metal, polymer, or composite materials. The window 180 is made of a material (e.g, calcium fluoride, quartz, magnesium oxide, glass, or sapphire) that is transparent (i.e., having an absorbance of less than about 10%) to the wavelengths of light used for the experiment. The o-ring 160 is made of any suitable polymeric material, such as Buna N, neoprene, silicone rubber, or the like. In one aspect, as shown in FIG. 1, the sample cell 100 includes a cell mounting plate 195 connected to the distal end 130 of the cell body 110.

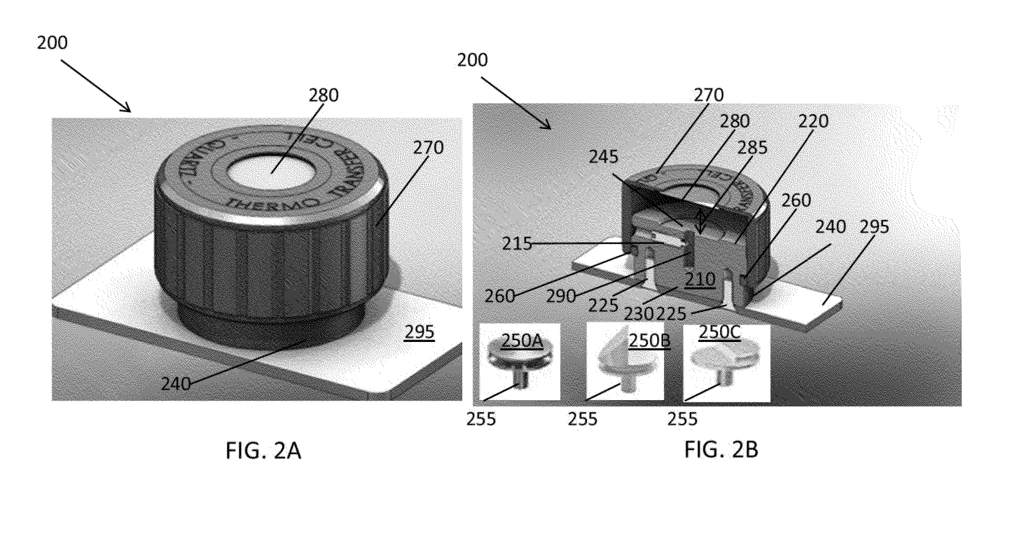

In another embodiment, as shown in perspective in FIG. 2A and in cross-section in FIG. 2B, a sample cell 200 includes a cell body 210 having a proximal end 220, a distal end 230, a circumference 240, and a sample holding surface 245 on the proximal end 220, an o-ring 260 around the circumference 240, a cap 270 disposed over the proximal end 220 of the cell body 210, the cap 270 forming a seal with the o-ring 260, and therefore maintaining a controlled atmosphere around sample holding surface 245. The sample cell 200 also includes a window 280 in the cap 270 located at an adjustable distance 285 from the sample holding surface 245. The window 280 is made of a material (e.g, calcium fluoride, quartz, magnesium oxide, glass, or sapphire) that is transparent (i.e., having an absorbance of less than about 10%) to the wavelengths of light used for the experiment.

In one aspect, as shown in FIG. 2B, the sample cell 200 includes a cell mounting plate 295 connected to the distal end 230 of the cell body 210 by bolts 225. The sample holding surface 245 can include a recess 290 adapted for a sample holder 250. Examples of SEM sample holders are shown in FIG. 2B as sample holders 250A, 250B, and 250C. The post 255 (also called a stub) of sample holders 250A, 250B, and 250C has a diameter adapted to fit into recess 290. In one aspect, the post 255 is secured in recess 290 by locking pin 215. If the sample holders 250A, 250B, and 250C are made of metal, such as stainless steel or aluminum, then they are typically coated with an insulating material to prevent electrical short circuits during SEM analysis. Sample holders 250B and 250C are examples of sample holders for analyzing cross-sections of a sample, by mounting a sample with the edge perpendicular to the flat surface of the holder and parallel to the pin 255. Sample materials can be disposed on sample holders 250A, 250B, or 250C and placed in sample cell 200 either before or after SEM analysis.

In yet another embodiment, as shown in FIG. 3, a sample cell 300 includes a cell body 310 having a proximal end 320, a distal end 330, a circumference 340, and a sample holding surface 345 on the proximal end 320, adapted for a sample holder 350 disposed on the sample holding surface 345. The sample cell 300 also includes an o-ring 360 around the circumference 340, a cap 370 disposed over the proximal end 320 of the cell body 310, the cap 370 forming a seal with the o-ring 360, and therefore maintaining a controlled atmosphere around sample holder 350. The sample cell 300 also includes a window 380 in the cap 370 located at an adjustable distance 385 from the sample holding surface 345. The distance 385 is adjustable due to the cap 370 and cell body 310 being configured with matching threads 365, so that the cap 370 can be lowered onto the cell body 310 while maintaining the seal with the o-ring 360. The window 380 is made of a material (e.g, calcium fluoride, quartz, magnesium oxide, glass, or sapphire) that is transparent (i.e., having an absorbance of less than about 10%) to the wavelengths of light used for the experiment.

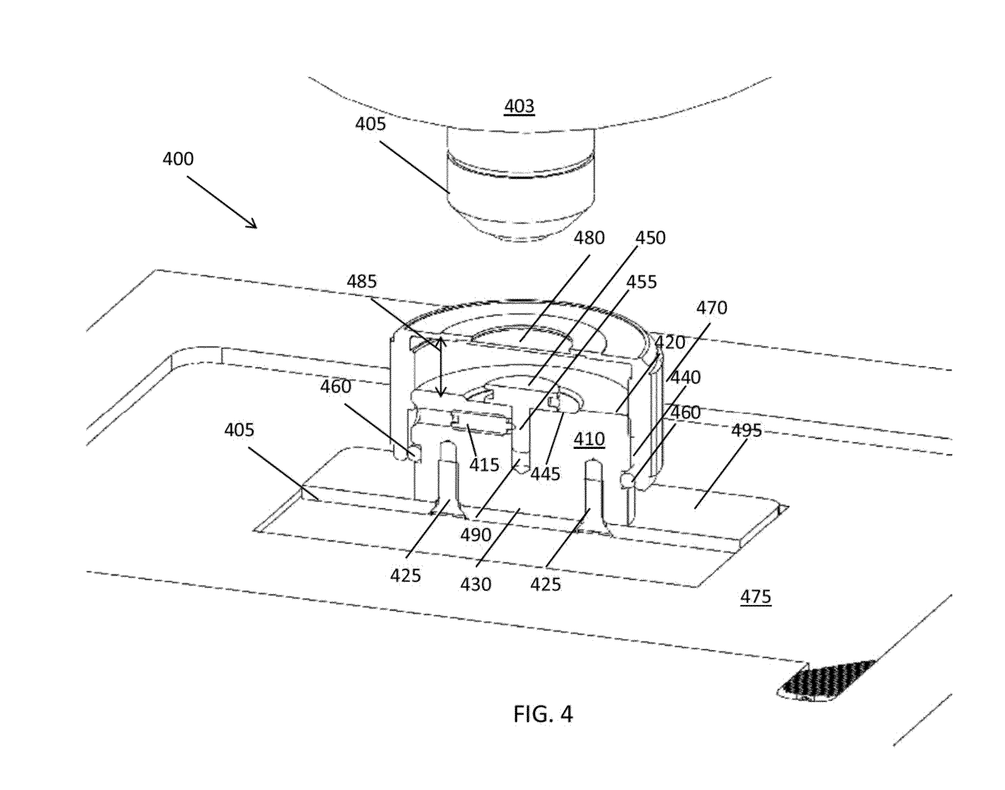

In one aspect, as shown in FIG. 3, the sample cell 300 includes a cell mounting plate 395 disposed on the XYZ sample stage 375 of a Raman microscope (see FIG. 4) Minimization of the adjustable distance 385 enables minimization of the focus distance 383 (also called the working distance) of the microscope objective 305, which enables higher magnification analysis of the sample on sample holder 350, because higher magnification microscope objectives 305 typically have shorter working distances 383. In one exemplary embodiment, the adjustable distance 385 is in a range of between 0.0 inches (0.0 cm) and 0.26 inches (0.66 cm), enabling a sample height in a range of between 0.25 inches (0.64 cm) and 0.01 inches (0.025 cm) to be fully enclosed by the sample cell 300. A preferred value of the adjustable distance 385 is 0.01 inches, so as to place the window 380 as close as possible to the sample (not shown) without making contact, where contact is an adjustable distance 385 of 0.0 inches. This preferred adjustable distance 385 yields a preferred value of 0.03 inches (0.08 cm) for the minimum working distance 383.

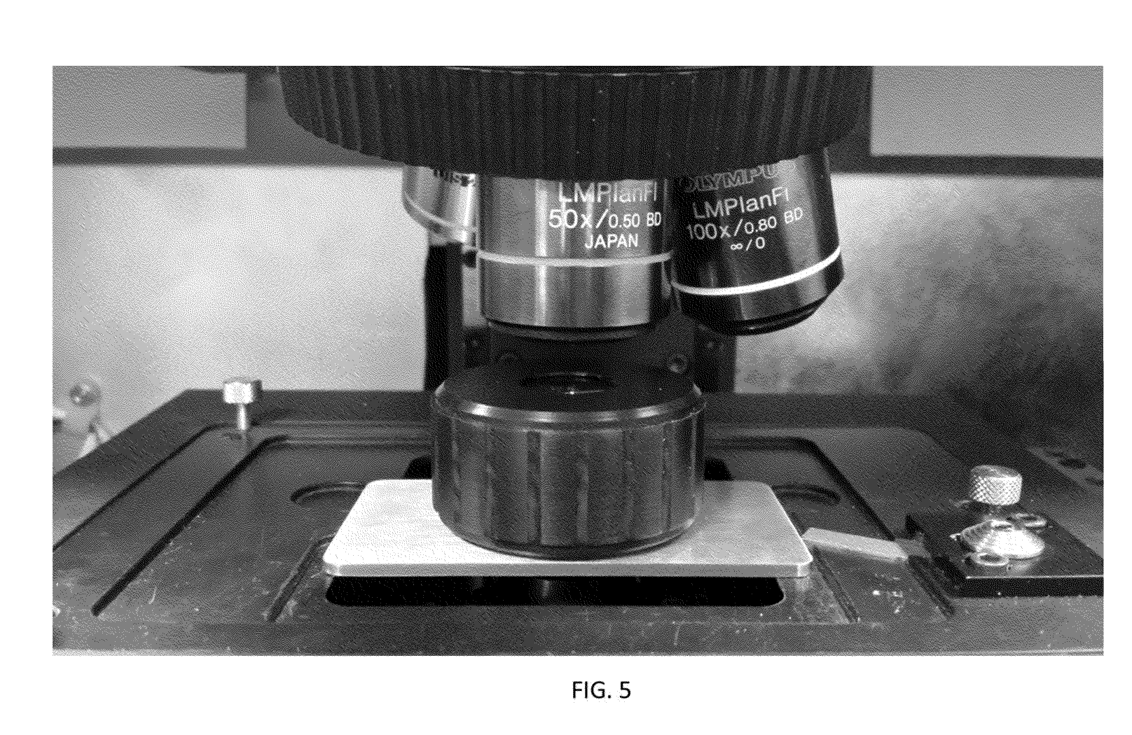

In still another embodiment, as shown in FIG. 4, a sample cell 400 includes a cell body 410 having a proximal end 420, a distal end 430, a circumference 440, and a sample holding surface 445 on the proximal end 420, adapted for a sample holder 450 disposed on the sample holding surface 445. The sample holding surface 445 can include a recess 490 adapted for a sample holder 450 that includes a post 455. In one aspect, the post 455 is secured in recess 490 by locking pin 415. The sample cell 400 also includes an o-ring 460 around the circumference 440, a cap 470 disposed over the proximal end 420 of the cell body 410, the cap 470 forming a seal with the o-ring 460, and therefore maintaining a controlled atmosphere around sample holder 450. The sample cell 400 also includes a window 480 in the cap 470 located at an adjustable distance 485 from the sample holding surface 445. The window 480 is made of a material (e.g, calcium fluoride, quartz, magnesium oxide, glass, or sapphire) that is transparent (i.e., having an absorbance of less than about 10%) to the wavelengths of light used for the experiment. In one aspect, as shown in FIG. 4, the sample cell 400 includes a cell mounting plate 495 connected to the distal end 430 of the cell body 410 by bolts 425. The cell mounting plate 495 is disposed on the XYZ sample stage 475 of a Raman microscope 403 that includes Raman microscope objective 405. A photograph of this embodiment is shown in FIG. 5.

The sample cell can be used for a variety of sample materials that can deteriorate rapidly in air, and therefore require handling in an inert (e.g., argon or nitrogen) atmosphere. Examples of such air-sensitive materials include lithium-ion battery components, such as electrode, separator, and solid electrolyte materials. Ex-situ lithium-ion battery material studies can include, for example, analysis of electrode materials, separator materials, and the solid electrolyte interphase (SEI) layer.

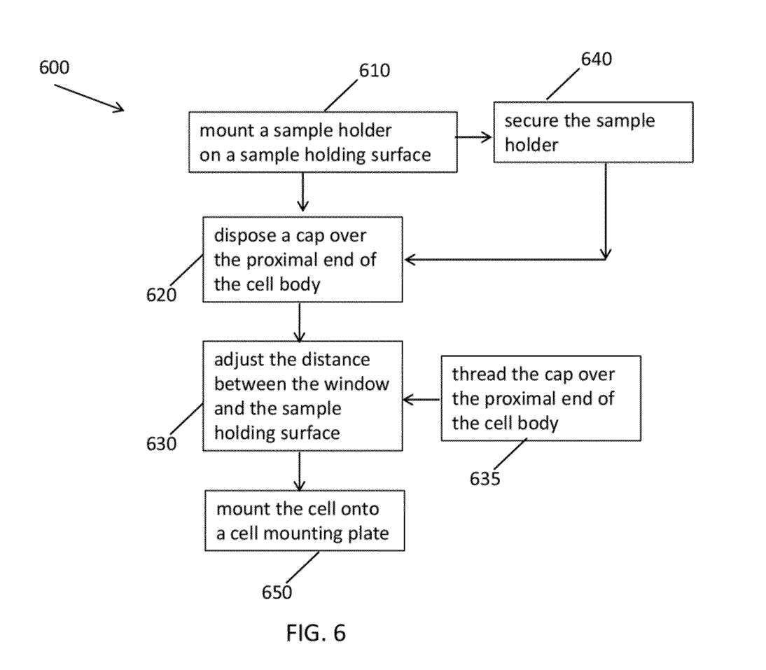

In another embodiment, shown in FIG. 6, a method 600 of holding a sample includes mounting at step 610 a sample holder on a sample holding surface located on a proximal end of a cell body having a circumference, and an o-ring around the circumference, disposing at step 620 a cap over the proximal end of the cell body, forming a seal with the o-ring, the cap including a window, and adjusting at step 630 the distance between the window and the sample holding surface. The method can further include securing at step 640 the sample holder with a locking pin, which can be located in a recess in the cell body. In some embodiments, the method can further include mounting the cell onto a cell mounting plate at step 650. In certain embodiments, adjusting the distance between the window and the sample holding surface at step 630 can include threading the cap over the proximal end of the cell body at step 635.

While the present invention has been illustrated by a description of an exemplary embodiment and while this embodiment has been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A sample cell comprising:
a. a cell body having a proximal end, a distal end, a circumference, and a sample holding surface on the proximal end;
b. an o-ring around the circumference;
c. a cap disposed over the proximal end of the cell body, the cap forming a seal with the o-ring; and
d. a window in the cap located at an adjustable distance from the sample holding surface.

2. The sample cell of claim 1, wherein the sample holding surface further includes a recess adapted for a sample holder.

3. The sample cell of claim 2, further including a locking pin that secures the sample holder in the recess.

4. The sample cell of claim 1, wherein the window is one of a calcium fluoride, quartz, glass, or magnesium oxide window.

5. The sample cell of claim 1, further including a cell mounting plate connected to the distal end of the cell body.

6. The sample cell of claim 1, wherein the cell body and cap include matching threads.

7. The sample cell of claim 1, wherein the cap has a diameter in a range of between 1.6 inches and 2.0 inches.

8. The sample cell of claim 7, wherein the cap as a diameter of 1.83 inches.

9. The sample cell of claim 1, wherein the adjustable distance is in a range between 0.0 inches and 0.26 inches.

10. The sample cell of claim 9, wherein the adjustable distance is 0.01 inches.

11. A method of holding a sample, the method comprising:
a. mounting a sample holder on a sample holding surface located on a proximal end of a cell body having a circumference, and an o-ring around the circumference;
b. disposing a cap over the proximal end of the cell body, forming a seal with the o-ring, the cap including a window; and
c. adjusting the distance between the window and the sample holding surface.

12. The method of claim 11, further including securing the sample holder with a locking pin.

13. The method of claim 12, wherein the locking pin is located in a recess in the cell body.

14. The method of claim 11, further including mounting the cell body onto a cell mounting plate.

15. The method of claim 11, wherein adjusting the distance between the window and the sample holding surface includes threading the cap over the proximal end of the cell body.
